(19) United States
(12) Patent Application Publication
(10) Pub. No.: US 2021/0060648 A1
(43) Pub. Date: Mar. 4, 2021

(54) METAL POWDER LAMINATION MOLDING METHODS AND METAL POWDER LAMINATION MOLDING APPARATUS

(71) Applicant: SODICK CO., LTD., KANAGAWA (JP)

(72) Inventors: Kenji ISHIBASHI, Kanagawa (JP); Shuji OKAZAKI, Kanagawa (JP)

(73) Assignee: SODICK CO., LTD., KANAGAWA (JP)

(21) Appl. No.: 16/999,069

(22) Filed: Aug. 21, 2020

(30) Foreign Application Priority Data
Aug. 29, 2019 (JP) 2019-156983

(51) Int. Cl. B22F 3/105; B33Y 10/00; B33Y 30/00; B33Y 50/02

(52) U.S. Cl. CPC B22F 3/1055; B33Y 10/00; B22F 2003/1057; B33Y 50/02; B33Y 30/00

(57) ABSTRACT

A work piece is damaged by a power failure or the like. Provided is a metal powder lamination apparatus, in which a control apparatus detects a load received by a blade while moving a recoater head along a B axis, stops the recoater head when the blade receives a load greater than or equal to a predetermined value, stores the position and height of an obstructive protrusion in a storage apparatus, repeatedly lowers a molding table by a predetermined height, and removes by planing only the largest obstructive protrusion among multiple obstructive protrusions after the recoater head moves to the end.

### CROSS-REFERENCE TO RELATED APPLICATION

This application claims the priority benefit of Japan application serial no. 2019-156983, filed on Aug. 29, 2019. The entirety of the above-mentioned patent application is hereby incorporated by reference herein and made a part of this specification.

### BACKGROUND

### Technical Field

The disclosure relates to metal powder lamination molding methods and a metal powder lamination molding apparatus. In particular, the disclosure relates to metal powder lamination molding methods and a metal powder lamination molding apparatus that remove an obstructive protrusion that obstructs recoating.

### Description of Related Art

For a metal 3D printer for producing a three-dimensional object made of metal, a metal powder lamination molding apparatus is known, which is configured to spray metal material powder on a molding area on a molding table, level the material powder evenly with a blade, and then repeatedly irradiate a predetermined irradiation area in the molding area with a laser beam or an electron beam to sinter or melt and solidify the material powder to laminate solidified layers so as to produce an object with a desired three-dimensional shape. Hereinafter, the action of forming a solidified layer by irradiating a laser beam or an electron beam is collectively referred to as melting and solidification including sintering.

In a metal powder lamination molding method, when a metal powder layer with a thickness of about 50 μm to 200 μm is irradiated by a laser beam or an electron beam with a high energy density, for example, a part of the material evaporates, and the evaporated material powder is cooled and solidified and drops onto the powder layer, whereby “obstructive protrusions” which have a height exceeding a predetermined height of the powder layer and obstruct recoating may be formed unintentionally. Although obstructive protrusions may be formed due to other causes, if obstructive protrusions are generated, the blade collides with the obstructive protrusions and does not move, and thus the molding cannot be continued.

Patent Document 1 discloses a lamination molding method which detects and removes obstructive protrusions. According to the invention of Patent Document 1, it is possible to avoid interruption of the automatic operation of the lamination molding apparatus and to continue the molding even if obstructive protrusions are generated. However, in the invention of Patent Document 1, it is necessary to remove the obstructive protrusions every time the obstructive protrusions are detected, which tends to increase the molding time. In addition, there is a possibility that a shaped part required for a molded object but similar to the obstructive protrusions may be accidentally damaged.

Patent Document 2 discloses a lamination molding method which removes the obstructive protrusions from the root. According to the invention of Patent Document 2, since the obstructive protrusions are substantially completely removed, the possibility that the blade repeatedly stops at the same place is reduced. As a result, it is advantageous in that the molding time may be shortened. However, in order to be able to remove every kind of obstructive protrusions, a cutting apparatus is required which has a machining head equipped with a spindle capable of relatively moving a cutting tool such as an end mill simultaneously in three axial directions while rotating it at a high speed; therefore, the lamination molding apparatus becomes relatively large in size.

Patent Document 3 discloses a lamination molding method using a flexible blade having a non-magnetic conductive property. According to the invention of Patent Document 3, since the blade rides over the obstructive protrusions, the molding work is unlikely to be interrupted. Further, according to the invention of Patent Document 3, the blade is unlikely to be damaged, and a shaped part required for the molded object but similar to the obstructive protrusions is unlikely to be damaged.

### RELATED ART

### Patent Document

[Patent Document 1] U.S. Pat. No. 7,754,135

[Patent Document 2] U.S. Pat. No. 10,625,340

[Patent Document 3] U.S. Pat. No. 10,081,131

### SUMMARY

### Technical Problem

There are various kinds of obstructive protrusions, and it is desirable to remove during molding an obstructive protrusion that may obstruct the continuous and stable molding work or may adversely influence the molding result. However, when the blade contacts the obstructive protrusion, it is difficult to determine what kind of obstructive protrusion it is, and it is also unclear whether there is another obstructive protrusion to be removed.

Therefore, it is required to provide a large-sized cutting apparatus having a high cutting capability so that the obstructive protrusions may be reliably removed regardless of the size, shape, location and number of the obstructive protrusions. Further, in order to avoid performing the operation of removing the obstructive protrusion each time an obstructive protrusion is detected, it is necessary to cut the entire irradiation area at the time when an obstructive protrusion is detected, which makes it difficult to shorten the molding time.

In view of the above circumstances, the disclosure mainly provides a metal powder lamination molding method which more reliably performs continuous and stable molding and further shortens the molding time. In particular, the disclosure provides a metal powder lamination molding apparatus which may be relatively small in size and may shorten the molding time. Some other advantages of the disclosure are shown in detail in the description of specific embodiments.

### Solution to the Problem

To address the above issues, the disclosure provides a metal powder lamination molding method of supplying metal material powder from a recoater head (6A) while leveling the metal material powder evenly with a blade (60B) provided in the recoater head (6A) to form a metal powder layer (4B) with a predetermined height in a predetermined molding area (α) on a molding table (4), and the metal powder lamination molding method includes: a first step of lowering the molding table (4) by the predetermined height; a second step of relatively moving the recoater head (6A) in a horizontal uniaxial direction from outside the molding area (α); a third step of stopping relative movement of the recoater head (6A) when detecting that the blade (60B) receives an overload greater than or equal to a predetermined load, and overwriting and storing in a storage apparatus (9R) a position of the recoater head (6A) in the horizontal uniaxial direction and a position of the molding table (4) in a vertical uniaxial direction at this time; a fourth step of lowering the molding table (4) by the predetermined height after the third step, and then relatively moving the recoater head (6A) in the horizontal uniaxial direction again; a fifth step of repeating the third step to the fourth step at least until the blade (60B) passes through the molding area (α); a sixth step of cutting with a fixed cutting edge for planing within a predetermined plane area centered on the positions stored in the storage apparatus (9R) when the load is detected in the third step; and a seventh step of returning the position of the molding table (4) to the position in the first step. It is preferable that the blade (60B) is a flexible blade having a non-magnetic conductive property.

Further, the disclosure provides a metal powder lamination molding apparatus, including: a recoater head (6A) which has a blade (60B) and which relatively moves in a horizontal uniaxial direction; a molding table (4) which has a predetermined molding area (α) on an upper surface and which relatively moves in a vertical uniaxial direction; a cutting apparatus (10) which cuts with a fixed cutting edge (10K) for planing; a control apparatus (9); and a storage apparatus (9R), wherein the control apparatus (9) moves the recoater head (6A) in the horizontal uniaxial direction for each metal powder layer (4B), stops relative movement of the recoater head (6A) when detecting that the blade receives an overload greater than or equal to a predetermined load, and overwrites and stores in the storage apparatus (9R) a position of the recoater head (6A) in the horizontal uniaxial direction and a position of the molding table (4) in the vertical uniaxial direction at this time, and the control apparatus (9) lowers the molding table (4) by a predetermined height and relatively moves the recoater head (6A) in the horizontal uniaxial direction again, and after the recoater head (6A) passes through the molding area (α) and reaches a predetermined position in the horizontal uniaxial direction, the control apparatus (9) operates the cutting apparatus (10) to perform cutting within a predetermined plane area centered on the positions stored in the storage apparatus (9R) when the recoater head (6A) is stopped once or more.

### Effects

According to the disclosure, since the cutting process is performed in the plane area for a necessary and sufficient range where there is a relatively large obstructive protrusion that has a significant influence on a molding result by stopping the recoater head only when the blade receives a large overload, the molding result is good, and the molding time is further shortened, and a cutting apparatus having a considerably high cutting capability for the work of removing the obstructive protrusion is not required, and the lamination molding apparatus does not become large in size.

### BRIEF DESCRIPTION OF THE DRAWINGS

FIG. 1 is a block diagram showing a metal powder lamination molding apparatus of the disclosure.

FIG. 2 is a perspective diagram showing the metal powder lamination molding apparatus of the disclosure.

FIG. 3 is a perspective diagram showing a recoater head of the metal powder lamination molding apparatus of the disclosure.

FIG. 4 is a block diagram showing a control apparatus of the metal powder lamination molding apparatus of the disclosure.

FIG. 5 is a schematic diagram showing a process of a metal powder lamination molding method of the disclosure.

FIG. 6 is a flowchart showing a process of the metal powder lamination molding method of the disclosure.

### DESCRIPTION OF THE EMBODIMENTS

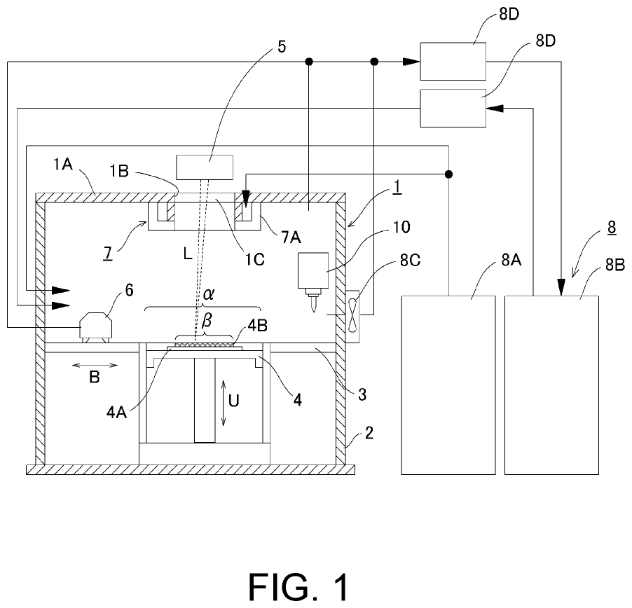

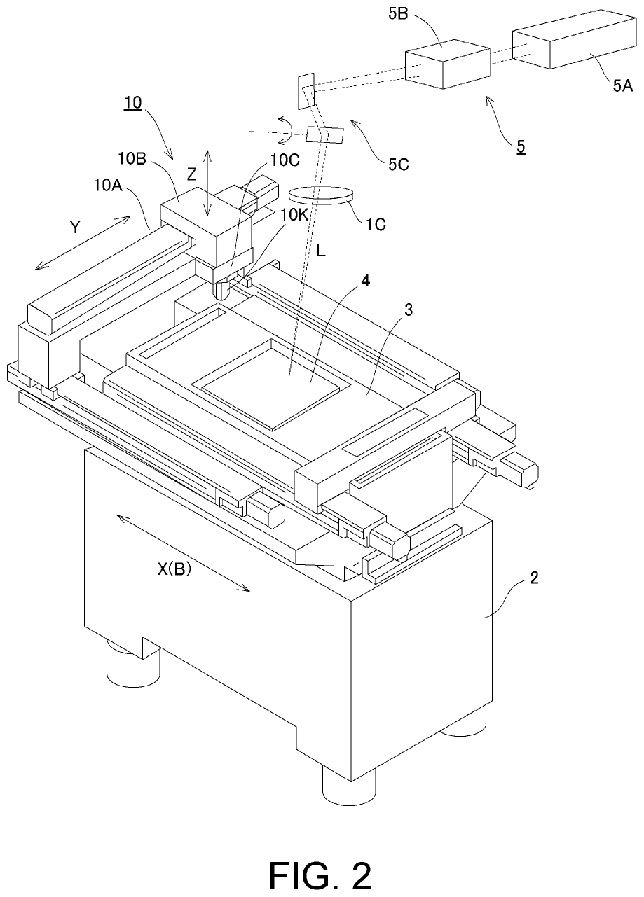

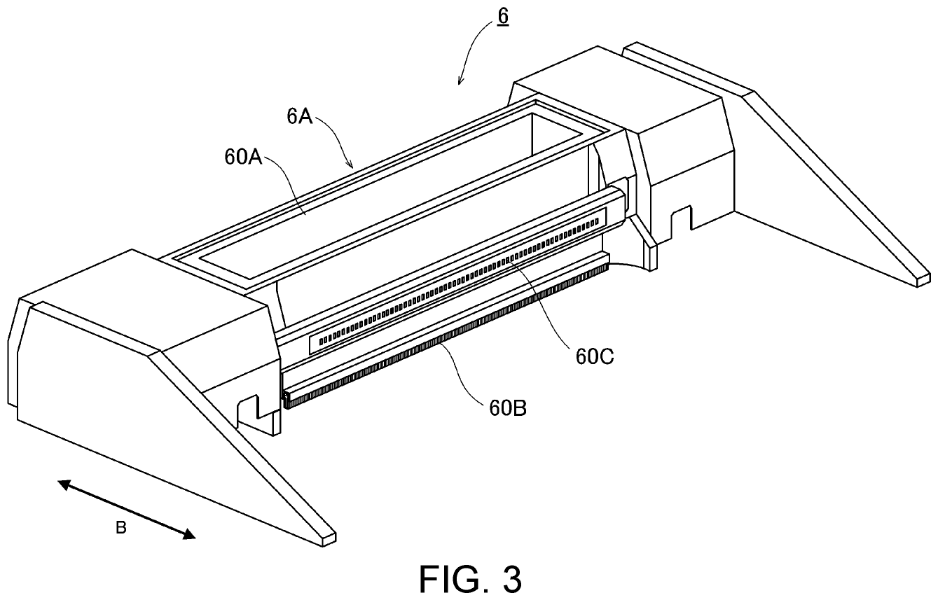

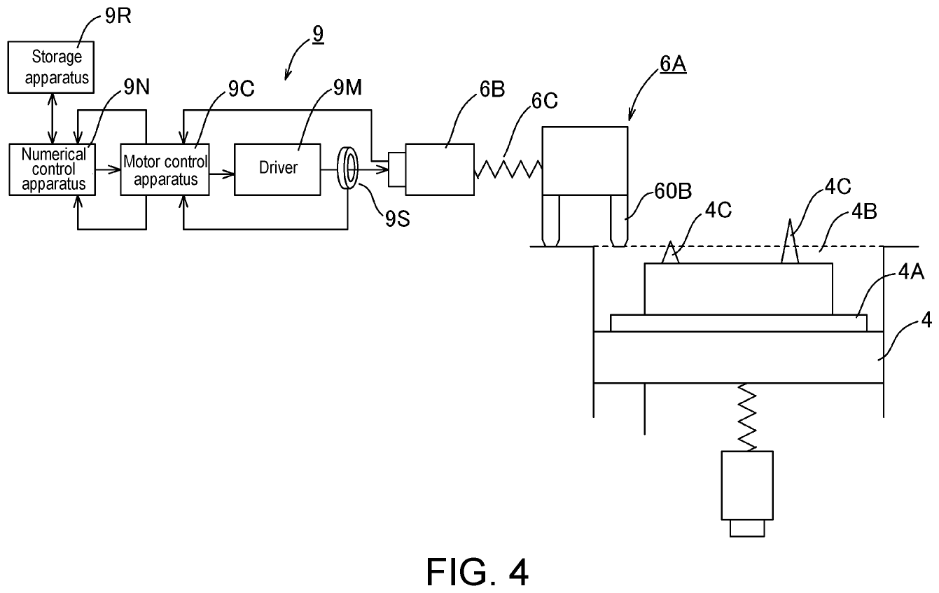

FIG. 1 shows an example of a metal powder lamination molding apparatus of the disclosure in a block diagram. FIG. 2 shows the lamination molding apparatus shown in FIG. 1 in a perspective diagram. The lamination molding apparatus shown in FIGS. 1 and 2 includes a planing apparatus including a fixed cutting edge capable of planing. FIG. 3 shows a recoater head shown in FIGS. 1 and 2 in a perspective diagram. FIG. 4 shows a control apparatus of the lamination molding apparatus of the disclosure, but parts not directly related to the disclosure are omitted in the drawing. Hereinafter, an exemplary metal powder lamination molding apparatus of the disclosure will be described with reference to FIGS. 1 to 4.

The metal powder lamination molding apparatus shown in FIGS. 1 and 2 includes a chamber 1, a bed 2, a base table 3, a molding table 4, a laser irradiation apparatus 5, a recoater 6, a fume protection apparatus 7, and an inert gas supply and discharge mechanism 8. A control apparatus 9 controls all operations of the lamination molding apparatus including the laser irradiation apparatus 5. Further, the lamination molding apparatus shown in FIGS. 1 and 2 includes a planing apparatus 10. In the lamination molding apparatus shown in FIG. 1, a predetermined molding area α is set on the upper surface of the molding table 4. Then, a predetermined irradiation area β surrounded by a contour shape of a molded object having a desired three-dimensional shape on a predetermined horizontal plane is set in the molding area α.

The chamber 1 is a molding chamber. During molding, the chamber 1 is filled with the inert gas supplied from the inert gas supply and discharge mechanism 8. The inert gas is a gas that does not substantially react with metal material powder. Specifically, the inert gas used in the lamination molding method of the disclosure is nitrogen gas. A top plate 1A on the upper surface of the chamber 1 is provided with an opening 1B through which a laser beam L passes. The opening 1B is closed by a window 1C made of a material that allows a predetermined type of laser beam L to pass therethrough substantially without absorption.

The bed 2 is a base of the lamination molding apparatus. The base table 3 is a work table. The base table 3 is disposed horizontally on the bed 2. The chamber 1 is fixedly disposed on the bed 2 to cover the entire upper surface of the base table 3. The central part of the work surface of the base table 3 has a through hole. The molding table 4 is provided to fit into the opening of the rectangular through hole.

The molding table 4 is a work table that moves up and down to form a partial area in the entire work surface of the base table 3. The molding table 4 moves reciprocally in a vertical uniaxial direction (U axis), which is the vertical direction, by a driving mechanism (not shown). About the entire upper surface of the molding table 4 corresponds to the molding area α. A base plate 4A is fixed to a predetermined position on the upper surface of the molding table 4. The predetermined irradiation area β is set on the base plate 4A.

The laser irradiation apparatus 5 is an apparatus for irradiating a powder layer 4B by the laser beam L. As specifically shown in FIG. 2, the laser irradiation apparatus 5 includes a laser beam source 5A, a focus unit 5B, and a pair of galvano units 5C. The laser beam output by the laser beam source 5A is a kind of laser beam suitable for sintering or melting the material powder. Specifically, the laser beam of the laser irradiation apparatus 5 shown in FIG. 2 is a YAG laser.

The laser beam with a specific frequency oscillated by the laser beam source 5A is condensed by the focus unit 5B and supplied to the galvano units 5C. The galvano units 5C rotate a pair of galvano mirrors by operating a rotary actuator (not shown) to control and change the irradiation direction of the laser beam L. For example, the galvano units 5C scan the laser beam so that the spot moves along a predetermined raster scan line. Further, the spot diameter of the laser beam L is adjusted by, for example, a condenser lens (not shown) provided between the galvano units 5C and the window 1C.

The recoater 6 is for forming the powder layer 4B by spraying the material powder and leveling it evenly. The recoater 6 includes a recoater head 6A and a driving apparatus including a servomotor 6B and a driving transmission apparatus 6C shown in FIG. 4. As shown in detail in FIG. 3, the recoater head 6A is provided at least with a material case 60A, a blade 60B, and a suction port 60C for sucking and discharging the nitrogen gas, which is the inert gas in the chamber 1, together with the fume to the outside of the chamber 1. The recoater head 6A moves reciprocally in a horizontal uniaxial direction (B axis), which is the left-right direction of the lamination molding apparatus.

Since there is almost no gap between the lower end of the blade 60B and the base table 3, the material powder is not substantially sprayed on the base table 3. At this time, when the molding table 4 is lowered so that the upper surface of the molding table 4 is located below the height position of the upper surface of the base table 3, the material powder is evenly supplied to the space formed above the molding table 4, and the powder layer 4B with a predetermined height is formed.

The blade 60B has a strip-shaped brush-like shape in which a large number of fibers are uniformly disposed in the longitudinal direction. The blade 60B may have flexibility capable of absorbing an impact due to a collision with an obstructive protrusion, or in other words, may have pliability, but it may have a flat plate shape as long as it may ride over the obstructive protrusions to some extent.

The blade 60B shown in FIG. 3 is demagnetized and electrostatically removed. More specifically, the blade 60B is made of a non-magnetic material having a magnetic susceptibility with an absolute value of 0.1 or less, and has electrical conductivity of 106 S/m or more and has heat resistance. More specifically, carbon fiber plastic, austenitic stainless steel, or brass is selected for the blade 60B. In particular, the blade 60B preferably has a bending stress in the range of 50 MPa or more and 150 MPa or less.

The fume protection apparatus 7 is provided on the top plate 1A on the upper surface of the chamber 1 to cover the window 1C. The fume protection apparatus 7 prevents the window 1C from being contaminated by the fume by pushing back the fume rising from the predetermined irradiation area β by the internal pressure of nitrogen gas in a cylindrical housing 7A filled with clean nitrogen gas supplied from the inert gas supply and discharge mechanism 8 so that the fume does not enter the space in the housing 7A.

The inert gas supply and discharge mechanism 8 includes an inert gas supply source 8A, a fume collector 8B, an exhaust fan 8C, and a duct box 8D. In the inert gas supply and discharge mechanism 8 in the lamination molding apparatus of the embodiment, the inert gas supply source 8A includes at least one liquefied nitrogen gas cylinder. The fume collector 8B adsorbs and removes from the nitrogen gas fine metal particles generated by cooling the fume contained in the dirty nitrogen gas collected from the chamber 1. The duct box 8D contains fine metal particles generated by the fume which cools in the path, and collects fine impurities contained in the gas.

The path for supplying the inert gas includes a first supply path from the inert gas supply source 8A to the chamber 1, a second supply path from the inert gas supply source 8A to the fume protection apparatus 7, and a third supply path from the fume collector 8B to the chamber 1. In addition, the path through which the inert gas is discharged together with the fume includes a first discharge path through which the inert gas is collected from the chamber 1 to the fume collector 8B through the exhaust fan 8C or not through the exhaust fan 8C, and a second discharge path through which the inert gas is collected from the suction port 60C of the recoater head 6A of the recoater 6 to the fume collector 8B.

The planing apparatus 10 includes a beam 10A which is moved and controlled by the control apparatus 9 shown in FIG. 4, a slider 10B, and a head 10C to which a fixed cutting edge 10K is attached. Specifically, the fixed cutting edge 10K is a cutting tool or shaper suitable for planing.

The beam 10A moves reciprocally in the horizontal uniaxial direction (X axis) parallel to the horizontal uniaxial direction (B axis) in which the recoater head 6A moves reciprocally. The slider 10B moves reciprocally above the beam 10A in another horizontal uniaxial direction (Y axis) which is the front-back direction of the lamination molding apparatus and is orthogonal to the X axis direction. The head 10C moves reciprocally in a vertical uniaxial direction (Z axis) orthogonal to the X axis direction and the Y axis direction. The planing apparatus 10 may perform cutting (planing) by moving the fixed cutting edge 10K (such as a shaper) in any three-dimensional direction by relatively moving the beam 10A, the slider 10B, and the head 10C through the control apparatus 9.

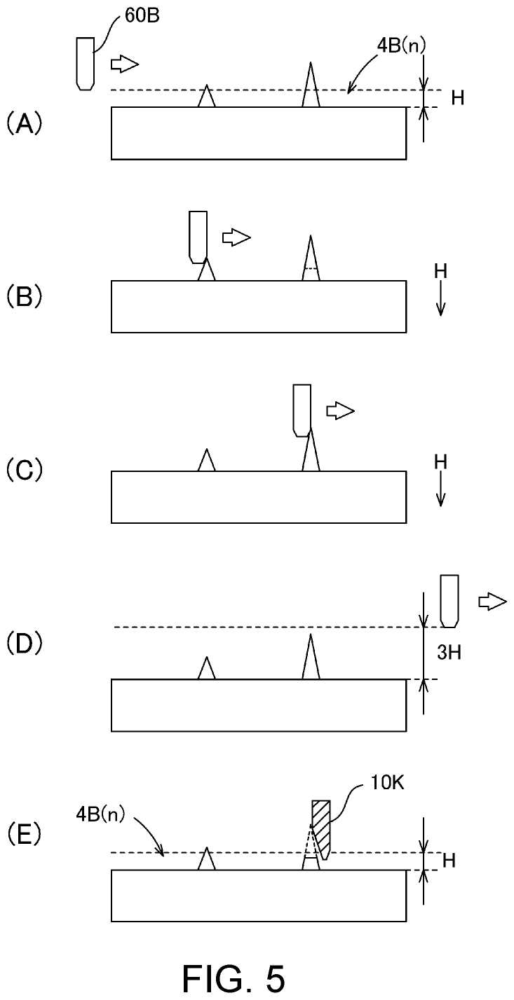

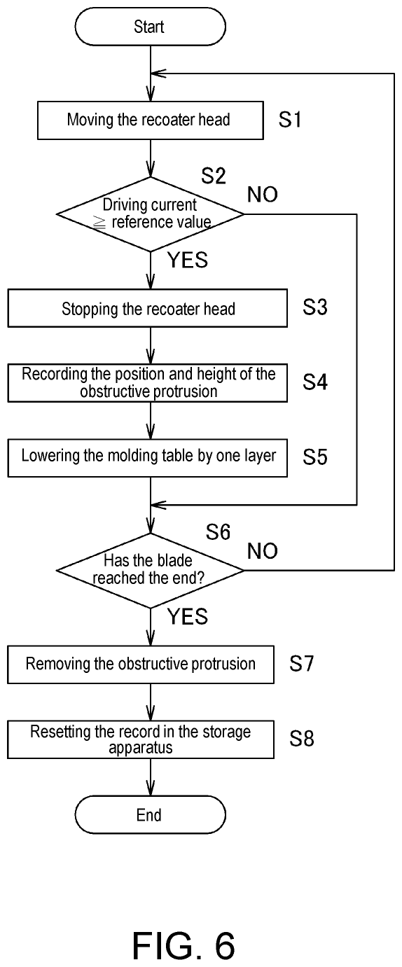

FIG. 4 shows a control system for performing the metal powder lamination molding method of the disclosure in a block diagram. FIG. 5 schematically shows the process of the lamination molding method of the disclosure. FIG. 6 shows the process of the lamination molding method of the disclosure in a flowchart. The metal powder lamination molding method of the disclosure will be described below.

As shown in (A) of FIG. 5, in step S51 of FIG. 6, the recoater head 6A is relatively moved in the horizontal uniaxial direction (B axis) from a predetermined start position of the base table 3 outside the molding area α to form the powder layer 4B. In the lamination molding method of the embodiment, in step S2 of FIG. 6, the load received by the blade 60B is indirectly measured by the magnitude of the driving current output from a motor driver 9M to the servomotor 6B.

For example, in the control apparatus 9, a current sensor 9S detects the driving current while the recoater head 6A is moving, and inputs the driving current to a numerical control apparatus 9N through a motor control apparatus 9C. Then, in the numerical control apparatus 9N, a predetermined reference value (reference data) is compared with a feedback current value (measurement data) of the driving current. The predetermined reference value (threshold value) is determined in advance based on a plurality pieces of information regarding the load when the blade 60B is actually damaged in the past or when defective molding occurs due to an obstructive protrusion.

When an obstructive protrusion 4C exceeding a predetermined height H for one powder layer is generated during molding, in the case where the blade 60B having flexibility rides over the obstructive protrusion 4C, the load received by the blade 60B does not exceed a predetermined load. Therefore, even if the blade 60B collides with the obstructive protrusion 4C, the recoater 6 continues the recoating. Therefore, the lamination molding method of the embodiment is advantageous in that the molding time does not become unnecessarily long.

On the other hand, when the blade 60B cannot ride over the obstructive protrusion 4C or when the obstructive protrusion 4C has such a size that it may cause defective molding in the future, the load received by the blade 60B is greater than or equal to the predetermined load. At this time, since the recoater head 6A does not move forward, in order to move the recoater head 6A forward, the motor control apparatus 9C instructs to increase the driving current output by the driver 9M. As a result, the feedback current of the driving current increases.

The measurement data of the driving current, which increases as the load received by the recoater head 6A increases and becomes greater than or equal to a predetermined reference value, substantially corresponds to an “overload signal,” and the control apparatus 9 sends the measurement data to the numerical control apparatus 9N through the motor control apparatus 9C. As a result, in step S3 of FIG. 6, the numerical control apparatus 9N determines that the driving current is greater than or equal to the predetermined reference value and that the undesired obstructive protrusion 4C is present, immediately stops the servomotor 6B, and keeps the recoater head 6A as close as possible to the position where it collides with the obstructive protrusion 4C.

In step S4 of FIG. 6, the control apparatus 9 stores in a storage apparatus 9R the position coordinate value of the recoater head 6A in the horizontal uniaxial direction (B axis) and the position coordinate value of the molding table 4 in the vertical uniaxial direction (U axis) for obtaining, by a position detector (encoder) (not shown), the upper surface of the sintered body during molding, that is, the position and height on the plane of the obstructive protrusion 4C formed in the solidified layer of the uppermost layer of the unfinished molded object.

When the blade 60B collides with the obstructive protrusion 4C and the recoater head 6A is stopped, the molding work is temporarily stopped in step S5 of FIG. 6, and as shown in (B) of FIG. 5, the molding table 4 is lowered by the predetermined height H of one powder layer. Then, returning to step S1 of FIG. 6, the recoater head 6A is moved again from the position where it collided with the obstructive protrusion 4C.

In step S2 of FIG. 6, when it is determined that the blade 60B again contacts the obstructive protrusion 4C and the recoater head 6A receives an overload, the control apparatus 9 determines in step S3 of FIG. 6 that the recoater head 6A is immediately stopped. Then, as shown in (C) of FIG. 5, in step S4 to step S5 of FIG. 6, the control apparatus 9 overwrites the previously recorded data of the position when the recoater head 6A is stopped and the position of the molding table 4 and stores the positions in the storage apparatus 9R, and the molding table 4 is lowered by the predetermined height H of one powder layer.

As shown in (D) of FIG. 5, in step S6 of FIG. 6, when the recoater head 6A is stopped once or more when the recoater head 6A moves to finish forming the powder layer 4B at least until the blade 60B of the recoater head 6A passes through the molding area α and reaches a predetermined end position in the horizontal uniaxial direction (B axis), then as shown in (E) of FIG. 5, in step S7 of FIG. 6, the planing apparatus 10 is activated to move the fixed cutting blade 10K to a position where there is a large obstructive protrusion 4C that protrudes in the highest position among the obstructive protrusions 4C that have been contacted so far and are recorded in the storage apparatus 9R. Then, the obstructive protrusion 4C is removed by planing so that the tip (peak) is lower than the predetermined height H of the current powder layer 4B(n).

When the largest obstructive protrusion 4C is removed, one process is ended, and the process returns to step Si of FIG. 6, and the powder layer 4B(n) is recoated again. Then, after the solidified layer is formed in the powder layer 4B(n), the subsequent powder layer is similarly recoated. In the metal powder lamination molding method of the embodiment, the data of the positions recorded in the storage apparatus 9R is erased in step S8 of FIG. 6. By erasing the record of the storage apparatus 9R, it becomes unnecessary in step S7 to determine whether or not the operation of removing the obstructive protrusion 4C is required, but step S8 is not an operation that must be performed.

According to the metal powder lamination molding method of the embodiment, a cutting apparatus equipped with a spindle to remove the obstructive protrusion 4C is not required, and the lamination molding apparatus may be small in size. Then, since the recoating is repeated while only the largest obstructive protrusion is removed with priority, there is an advantage that the entire molding time becomes shorter.

The disclosure is not limited to the lamination molding apparatus of the above-described embodiment, and may be modified, replaced, or combined with other disclosures without departing from the technical idea of the disclosure, as some examples have been specifically shown. For example, in the metal powder lamination molding apparatus of the embodiment, the load received by the blade is indirectly detected by the driving current of the servomotor, but the load of the blade may be directly detected by a pressure sensor or may be detected by the torque of the servomotor.

### INDUSTRIAL APPLICABILITY

The disclosure is useful for manufacturing a molded object having a three-dimensional shape made of metal. In particular, the disclosure provides a good effect in shortening the molding time in the metal powder lamination molding method. Further, the disclosure contributes to the technical progress in three-dimensional molding.

What is claimed is:

1. A metal powder lamination molding method comprising:
a first step of lowering a molding table by a predetermined height;
a second step of relatively moving a recoater head in a horizontal uniaxial direction from outside a molding area, and supplying metal material powder from the recoater head while leveling the metal material powder evenly with a blade;
a third step of stopping relative movement of the recoater head when detecting that the blade receives an overload greater than or equal to a predetermined load, and overwriting and storing in a storage apparatus a position of the recoater head in the horizontal uniaxial direction and a position of the molding table in a vertical uniaxial direction at this time;
a fourth step of lowering the molding table by the predetermined height after the third step, and then relatively moving the recoater head in the horizontal uniaxial direction again;
a fifth step of repeating the third step to the fourth step at least until the blade passes through the molding area;
a sixth step of cutting with a fixed cutting edge for planing within a predetermined plane area centered on the positions stored in the storage apparatus when the load is detected in the third step; and
a seventh step of returning the position of the molding table to the position in the first step.

2. The metal powder lamination molding method according to claim 1, wherein the blade is a flexible blade having a non-magnetic conductive property.

3. A metal powder lamination molding apparatus, comprising:
a recoater head which has a blade and which relatively moves in a horizontal uniaxial direction;
a molding table which has a predetermined molding area on an upper surface and which relatively moves in a vertical uniaxial direction;
a cutting apparatus which cuts with a fixed cutting edge for planing;
a control apparatus; and
a storage apparatus,
wherein the control apparatus moves the recoater head in the horizontal uniaxial direction for each metal powder layer, stops relative movement of the recoater head when detecting that the blade receives an overload greater than or equal to a predetermined load, and overwrites and stores in the storage apparatus a position of the recoater head in the horizontal uniaxial direction and a position of the molding table in the vertical uniaxial direction at this time, and
the control apparatus lowers the molding table by a predetermined height and relatively moves the recoater head in the horizontal uniaxial direction again, and after the recoater head passes through the molding area, the control apparatus operates the cutting apparatus to perform cutting within a predetermined plane area centered on the positions stored in the storage apparatus when the recoater head is stopped once or more.

4. The metal powder lamination molding apparatus according to claim 3, wherein the blade is a flexible blade having a non-magnetic conductive property.
